(19) United States
(12) Patent Application Publication
(10) Pub. No.: US 2006/0125366 A1
(43) Pub. Date: Jun. 15, 2006

(54) Plasma display apparatus comprising filter

(75) Inventor: Myeong Soo Chang, Uiwang-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/296,427

(22) Filed: Dec. 8, 2005

(30) Foreign Application Priority Data
Dec. 9, 2004 (KR) 10-2004-0103844

(51) Int. Cl. H01J 61/40; H01J 5/16; H01K 1/26; H01K 1/30

(52) U.S. Cl. 313/112

(57) ABSTRACT

This document relates to a plasma display apparatus comprising a filter. The plasma display apparatus of the embodiment of the present invention comprises a plasma display panel that radiates light, and a filter comprising a concentrating layer disposed over the plasma display panel, for concentrating the light, and a light-transmitting layer disposed on the concentrating layer and having a plurality of apertures through which the concentrated light passes formed therein. The plasma display apparatus of the embodiment of the present invention can improve the brightness and contrast ratio and shields EMI.

### CROSS-REFERENCES TO RELATED APPLICATIONS

This Nonprovisional application claims priority under 35 U.S.C. § 119(a) on Patent Application No. 10-2004-0103844 filed in Korea on Dec. 09, 2004 the entire contents of which are hereby incorporated by reference.

### BACKGROUND OF THE INVENTION

1. Field of the Invention

This document relates to a plasma display apparatus comprising a filter.

2. Background of the Related Art

In general, a plasma display panel consists of a front substrate and a rear substrate made of soda-lime glass. Barrier ribs formed between the front substrate and the rear substrate partition discharge cells. An inert gas injected into the discharge cells, such as helium-xeon (He—Xe) or helium-neon (He—Ne) generates a discharge with a high frequency voltage. When a discharge is generated, vacuum ultraviolet rays are generated. Vacuum ultraviolet rays light-emit phosphors formed between the barrier ribs, implementing images.

FIG. 1 schematically shows the construction of a plasma display apparatus in the related art. As shown in FIG. 1, the related art plasma display apparatus comprises a casing 110 comprising a front cabinet 111 and a back cover 112, a plasma display panel 120 mounted in the casing 110, a driving apparatus 130 for driving the plasma display panel 120, and a frame 140 coupled to the driving apparatus 130, for dissipating heat generating when the plasma display panel is driven and supporting the plasma display panel.

The related art plasma display apparatus further comprises a filter 150 whose film is attached to a transparent glass substrate (not shown), a filter spring gasket 160 and a filter supporter 170, which support the filter 150 and are electrically connected to the back cover 112, and a module supporter 180 for supporting the driving apparatus 130 and the plasma display panel 120.

The related art plasma display apparatus implements images using a driving pulse of a high voltage and a high frequency for the purpose of a plasma discharge. Therefore, there is a problem in that a great amount of Electromagnetic Interference (hereinafter referred to as “EMI”), which is generated by the driving pulse, is dissipated through a front glass. More particularly, an amount of EMI generated by the plasma display apparatus is greater than that generated by a Cathode Ray Tube (CRT) or a Liquid Crystal Display (LCD).

The prior art plasma display apparatus radiates Near Infrared Rays (hereinafter referred to as “NIR”) generated by an inert gas such as Ne or Xe. The NIR generated from the prior art plasma display apparatus is problematic in that it causes malfunction because it is very close to a wavelength of NIR output from a remote controller of home appliances. Furthermore, a problem arises because a user may feel dazzling due to external light as in CRT or LCD. There is also a problem, such as a low contrast ratio, which is one of picture quality characteristics of other display apparatuses.

Therefore, the prior art plasma display apparatus comprises a filter capable of reducing or obviating EMI or NIR. The filter of the plasma display apparatus can be classified into a glass filter and a film filter depending on its structure.

FIG. 2 shows the construction of a plasma display apparatus comprising a glass filter in the related art. As shown in FIG. 2, the glass filter of the prior art plasma display apparatus comprises a transparent glass substrate 151 spaced apart from the plasma display panel 120 at a predetermined distance, an anti-reflection film 152 formed on the transparent glass substrate 151, a color-dye film 153 adjacent to the transparent glass substrate 151, for shielding NIR and controlling color, and an EMI-shielding film 154 for shielding EMI. The transparent glass substrate 151 serves as a base forming the filter and protects the plasma display panel from external shock.

FIG. 3 shows the construction of a plasma display apparatus comprising a film filter in the related art. As shown in FIG. 3, the prior art film filter 350 comprises an EMI-shielding film 154, a color-dye film 153 and an anti-reflection film 152. The prior art film filter is directly attached to a front substrate 121 of the plasma display panel by means of a lamination method, etc.

The EMI-shielding film 154 of the glass filter and the film filter in the related art is formed using a black layer of a mesh type in order to improve the contrast ratio. The black layer functions to lower the transmittance of light, which is incident on the filter from the outside and thus to lower light reflecting from the surface of the plasma display. Therefore, the contrast ratio of the plasma display apparatus can be improved. However, the black layer included in the glass filter or the film filter of the related art shields light generated when the plasma display panel is driven. That is, the black layer included in the filter lowers the aspect ratio and reduces brightness.

### SUMMARY OF THE INVENTION

Accordingly, an object of the embodiment of the present invention is to solve at least the problems and disadvantages of the background art.

It is an object of the embodiment of the present invention to provide a plasma display apparatus comprising a filter, in which it can reduce a reduction in brightness and improve the contrast ratio.

A plasma display apparatus according to an aspect of the present invention comprises a plasma display panel radiating light, and a filter comprising a concentrating layer disposed over the plasma display panel, for concentrating the light, and a light-transmitting layer disposed on the concentrating layer and comprising a plurality of apertures through which the concentrated light passes.

A filter according to an aspect of the present invention comprises a concentrating layer disposed over the plasma display panel, for concentrating the light, and a light-transmitting layer disposed on the concentrating layer and comprising a plurality of apertures through which the concentrated light passes formed therein.

It is thus possible to improve brightness and the contrast ratio and shield EMI.

### BRIEF DESCRIPTION OF THE DRAWINGS

The embodiment of the invention will be described in detail with reference to the following drawings in which like numerals refer to like elements.

FIG. 1 schematically shows the construction of a plasma display apparatus in the related art;

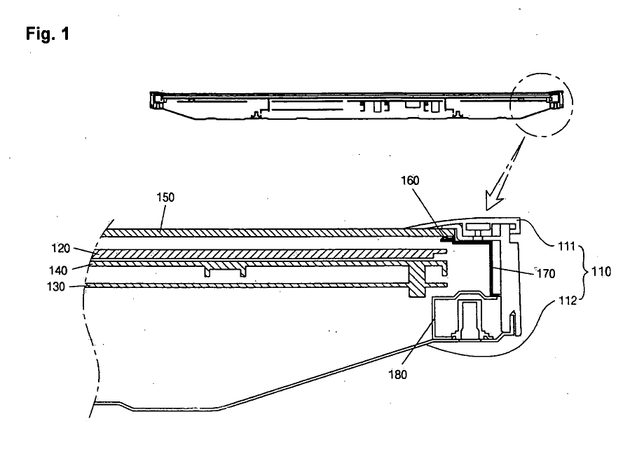

FIG. 2 shows the construction of a plasma display apparatus comprising a glass filter in the related art;

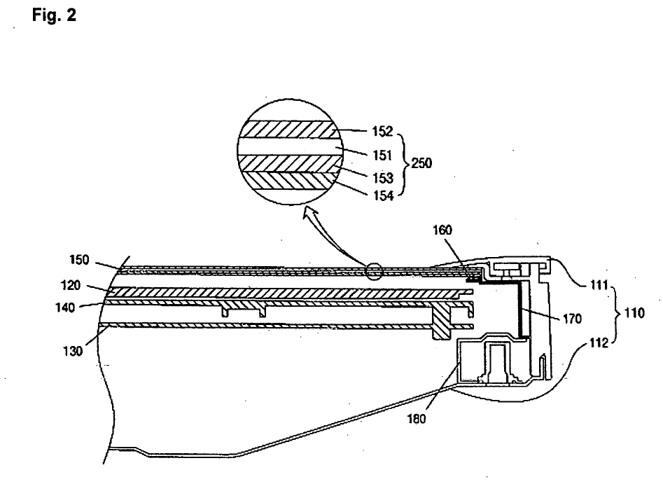

FIG. 3 shows the construction of a plasma display apparatus comprising a film filter in the related art;

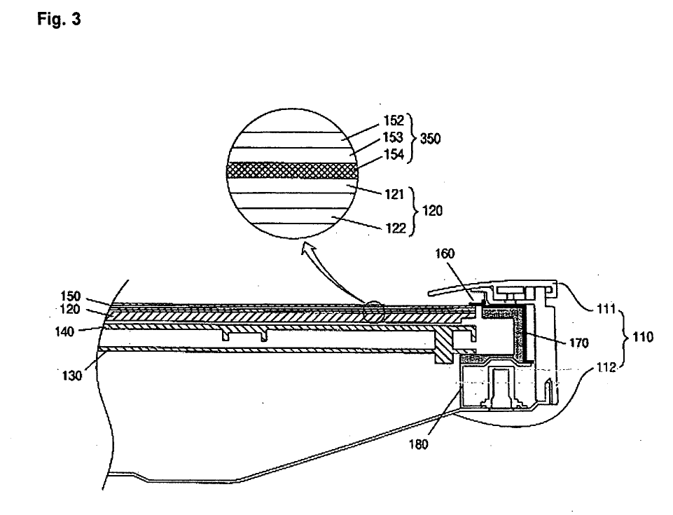

FIG. 4 shows the construction of a plasma display apparatus comprising a film filter according to an embodiment of the present invention; and

FIG. 5 shows the construction of a plasma display apparatus comprising a glass filter according-to an embodiment of the present invention.

### DETAILED DESCRIPTION OF THE PREFERRED EMBODIMENT

Embodiments of the present invention will be described in a more detailed manner with reference to the drawings.

A plasma display apparatus according to an aspect of the present invention comprises a plasma display panel radiating light, and a filter comprising a concentrating layer disposed over the plasma display panel, for concentrating the light, and a light-transmitting layer disposed on the concentrating layer and comprising a plurality of apertures through which the concentrated light passes.

The light-transmitting layer may be a conductive mesh layer.

The conductive mesh layer may be made of a black conductive material.

The conductive mesh layer may be grounded.

The conductive mesh layer may be a copper mesh layer.

The copper mesh layer may comprise a surface blackened by means of oxidization.

The light-transmitting layer may comprise a surface blackened by means of oxidization.

The concentrating layer may be a micro lens array comprising a plurality of unit lenses.

Each of the unit lenses may comprise a convex shape in the direction to the plasma display panel.

The focus of one of the unit lenses may be formed in one aperture.

The filter may be either of a glass filter or a film filter.

A filter according to an aspect of the present invention comprises a concentrating layer disposed over the plasma display panel, for concentrating the light, and a light-transmitting layer disposed on the concentrating layer and having a plurality of apertures through which the concentrated light passes.

The light-transmitting layer may be a conductive mesh layer.

The conductive mesh layer may be made of a black conductive material.

The conductive mesh layer may be a copper mesh layer.

The copper mesh layer may comprise a surface blackened by means of oxidization.

The light-transmitting layer may comprise a surface blackened by means of oxidization.

The concentrating layer may be a micro lens array comprising a plurality of unit lenses.

Each of the unit lenses may comprise a convex shape in an opposite direction to the light-transmitting layer.

The focus of one of the unit lenses may be formed in the one aperture.

It is thus possible to improve brightness and the contrast ratio and shield EMI.

Detailed embodiments of the present invention will be described below with reference to the accompanying drawings.

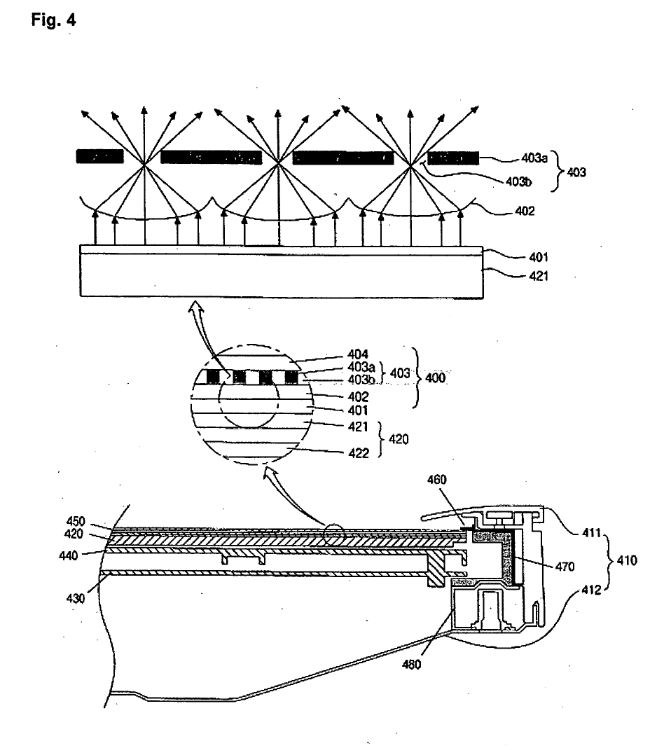

FIG. 4 shows the construction of a plasma display apparatus comprising a film filter according to an embodiment of the present invention. As shown in FIG. 4, the plasma display apparatus of the present invention comprises a casing 410 comprising a front cabinet 411 and a back cover 412, which decide an external form, a plasma display panel 420 mounted within a casing, a driving circuit substrate 430 for driving the plasma display panel 420, a heat dissipation sheet 440 coupled to the driving circuit substrate 430, for dissipating heat to the outside, a film filter 400 comprising a concentrating layer 402 that enhances the contrast ratio and brightness, a filter supporter 470 that supports the film filter 400 and is electrically connected to the back cover 412, and a module supporter 480 that supports the driving circuit substrate 430 and the plasma display panel 420.

The film filter 400 of the present invention comprises a NIR-shielding film 401 that shields NIR, an EMI-shielding film 403 that shields EMI, an anti-reflection film 404 that prevents the reflection of incident light, and the concentrating layer 402 for enhancing the contrast ratio and brightness.

The EMI-shielding film 403 of the film filter 400 is a black layer 403a of a mesh type, which comprises a plurality of apertures 403b. The black layer 403a comprises a copper mesh whose surface is oxidized and then blackened. Therefore, the black layer 403a has a good electrical conductivity while having a black color. Therefore, the black layer 403a reduces light reflected from the surface of the plasma display panel, thus improving the contrast ratio of the plasma display apparatus. Furthermore the black layer 403a is grounded and therefore shields EMI generated by the plasma display panel.

The concentrating layer 402 is disposed over the plasma display panel 420 that radiates light corresponding to an image. The black layer 403a that serves as the EMI-shielding film 403 is disposed on the concentrating layer 402. The concentrating layer 402 can be a micro lens array.

The micro lens array used as the concentrating layer 402 comprises a plurality of unit lenses. Each of the unit lenses comprises a convex shape in the direction to a front substrate 421. If each unit lens comprises a convex shape in the direction to the front substrate 421, light passing through the unit lens is concentrated into a focus of the unit lens. If light radiated from the front substrate 421 of the plasma display panel to the outside passes through the micro lens array (i.e., the concentrating layer 402), it is concentrated on a focus of the micro lens array.

The focus of the unit lens of the micro lens array is located at the center of one of the apertures 403b of the black layer 403a. Light that has passed through the unit lens of the micro lens array 402 is concentrated at the center of the aperture 403b where the focus of the unit lens is located, and is then radiated to the outside.

Since light is concentrated at the center of the aperture 403b by means of the micro lens array of the concentrating layer 403, the brightness of the plasma display apparatus can be enhanced.

Furthermore, most of light, which is incident on the front substrate 421 of the plasma display panel 420 from the outside, is absorbed by the black layer 403a. Light that is incident through the aperture 403b of the black layer 403a is absorbed by the black layer 403a again although it is reflected from the front substrate 421 of the plasma display panel. As a result, since an amount of light reflected from the front substrate of the plasma display panel is reduced, the contrast ratio can be improved.

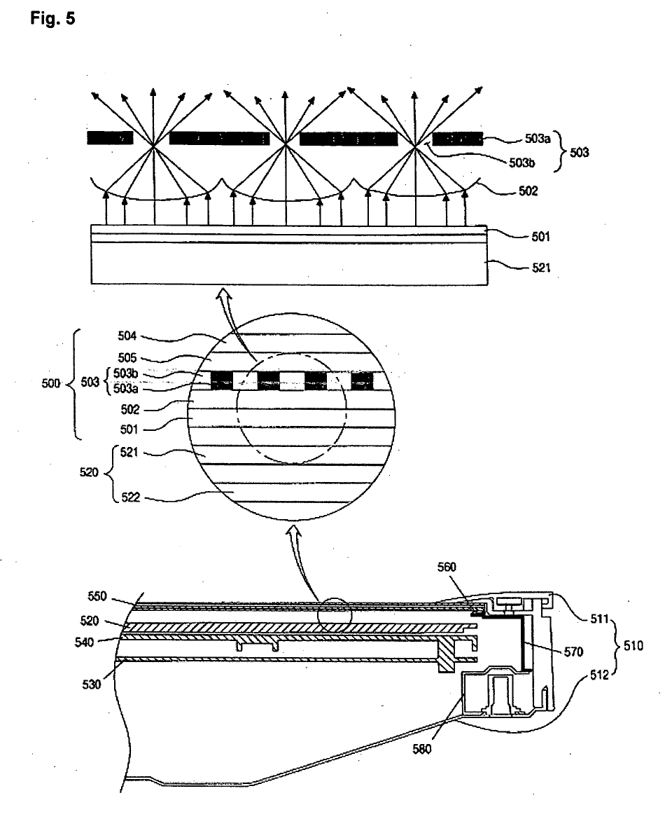

FIG. 5 shows the construction of a plasma display apparatus comprising a glass filter according to an embodiment of the present invention. As shown in FIG. 5, the plasma display apparatus of the present invention comprises a casing 510 comprising a front cabinet 511 and a back cover 512, which decide an external form, a plasma display panel 520 mounted within a casing, a driving circuit substrate 530 for driving the plasma display panel 520, a heat dissipation sheet 540 coupled to the driving circuit substrate 530, for dissipating heat to the outside, a glass filter 500 comprising a concentrating layer 502 that enhances the contrast ratio and brightness, a filter supporter 570 that supports the glass filter 500 and is electrically connected to the back cover 512, and a module supporter 580 that supports the driving circuit substrate 530 and the plasma display panel 520.

The glass filter 500 of the present invention comprises a NIR-shielding film 501, the concentrating layer 502 for improving the contrast ratio and brightness, an EMI-shielding film 503, a glass substrate 505 and an anti-reflection film 504.

The NIR-shielding film 501, the EMI-shielding film 503 and the anti-reflection film 504 have the same functions as those of the NIR-shielding film 501, the EMI-shielding film 503 and the anti-reflection film 504 included in the film filter. Therefore, detailed description thereof will be omitted.

The glass substrate 505 serves as a base for forming the NIR-shielding film 501, the concentrating layer 502, the EMI-shielding film 503 and the anti-reflection film 504, and protects the plasma display panel 520.

The EMI-shielding film 503 of the glass filter 500 is a black layer 503a of a mesh type, which comprises apertures 503b. The black layer 503a comprises a copper mesh whose surface is oxidized and then blackened. Therefore, the black layer 503a can improve the contrast ratio of the plasma display apparatus. Furthermore, the black layer 503a is grounded and shields EMI generated by the plasma display panel.

The concentrating layer 502 is disposed over the plasma display panel. The black layer 503a serving as the EMI-shielding film 503 is disposed on the concentrating layer 502. The concentrating layer 502 is a micro lens array.

The micro lens array used as the concentrating layer 502 comprises a plurality of unit lenses that have a convex shape in the direction to the front substrate 521. If each of the unit lenses comprises a convex shape in the direction to the front substrate 521, light that has radiated from the plasma display panel 520 and then passes through the unit lens gathers at a focus of the unit lens.

The focus of the unit lens of the micro lens array is located at the center of one of the apertures 503b of the black layer 503a. Light that has passed through the unit lens of the micro lens array 502 is concentrated at the center of the aperture 503b where the focus of the unit lens is located, and is then radiated to the outside.

Since light is concentrated at the center of the aperture 503b by means of the micro lens array of the concentrating layer 503, the brightness of the plasma display apparatus can be enhanced.

Furthermore, most of light, which is incident on the front substrate 521 of the plasma display panel 520 from the outside, is absorbed by the black layer 503a. Light that is incident through the aperture 503b of the black layer 503a is absorbed by the black layer 503a again although it is reflected from the front substrate 521 of the plasma display panel. As a result, since an amount of light reflected from the front substrate of the plasma display panel is reduced, the contrast ratio can be improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel radiating light; and
a filter comprising a concentrating layer disposed over the plasma display panel, for concentrating the light, and a light-transmitting layer disposed on the concentrating layer and comprising a plurality of apertures through which the concentrated light passes.

2. The plasma display apparatus as claimed in claim 1, wherein the light-transmitting layer is a conductive mesh layer.

3. The plasma display apparatus as claimed in claim 2, wherein the conductive mesh layer is made of a black conductive material.

4. The plasma display apparatus as claimed in claim 2, wherein the conductive mesh layer is grounded.

5. The plasma display apparatus as claimed in claim 2, wherein the conductive mesh layer is a copper mesh layer.

6. The plasma display apparatus as claimed in claim 5, wherein the copper mesh layer comprises a surface blackened by means of oxidization.

7. The plasma display apparatus as claimed in claim 1, wherein the light-transmitting layer comprises a surface blackened by means of oxidization.

8. The plasma display apparatus as claimed in claim 1, wherein the concentrating layer is a micro lens array comprising a plurality of unit lenses.

9. The plasma display apparatus as claimed in claim 8, wherein each of the unit lenses comprises a convex shape in the direction to the plasma display panel.

10. The plasma display apparatus as claimed in claim 8, wherein the focus of one of the unit lenses is formed in one aperture.

11. The plasma display apparatus as claimed in claim 1, wherein the filter is either of a glass filter or a film filter.

12. A filter disposed over a plasma display panel radiating light, comprising:
a concentrating layer disposed over the plasma display panel, for concentrating the light; and
a light-transmitting layer disposed on the concentrating layer and comprising a plurality of apertures through which the concentrated light passes.

13. The filter as claimed in claim 12, wherein the light-transmitting layer is a conductive mesh layer.

14. The filter as claimed in claim 13, wherein the conductive mesh layer is made of a black conductive material.

15. The filter as claimed in claim 13, wherein the conductive mesh layer is a copper mesh layer.

16. The filter as claimed in claim 15, wherein the copper mesh layer comprises a surface blackened by means of oxidization.

17. The filter as claimed in claim 12, wherein the light-transmitting layer comprises a surface blackened by means of oxidization.

18. The filter as claimed in claim 12, wherein the concentrating layer is a micro lens array comprising a plurality of unit lenses.

19. The filter as claimed in claim 8, wherein each of the unit lenses has a convex shape in an opposite direction to the light-transmitting layer.

20. The filter as claimed in claim 18, wherein the focus of one of the unit lenses is formed in the one aperture.
